(19) United States
(12) Patent Application Publication
(10) Pub. No.: US 2014/0027346 A1
(43) Pub. Date: Jan. 30, 2014

(54) SPHERICAL MATERIAL COMPRISING METALLIC NANOPARTICLES TRAPPED IN A MESOSTRUCTURED OXIDE MATRIX AND ITS USE AS A CATALYST IN REFINING PROCESSES

(71) Applicants: Alexandra Chaumonnot, Lyon (FR); Clement Sanchez, Bures-Sur-Yvette (FR); Cedric Boissiere, Paris (FR); Frederic Colbeau-Justin, Ivry-Sur-Seine (FR); Audrey Bonduelle, Francheville (FR)

(72) Inventors: Alexandra Chaumonnot, Lyon (FR); Clement Sanchez, Bures-Sur-Yvette (FR); Cedric Boissiere, Paris (FR); Frederic Colbeau-Justin, Ivry-Sur-Seine (FR); Audrey Bonduelle, Francheville (FR)

(73) Assignees: CENTRE NATIONAL DE LA RECHERCHE SCIENTIFIQUE, Paris Cedex 16 (FR); IFP ENERGIES NOUVELLES, Rueil Malmaison Cedex (FR); UNIVERSITE PIERRE ET MARIE CURIE, Paris Cedex 05 (FR)

(21) Appl. No.: 13/995,531

(22) PCT Filed: Dec. 15, 2011
(86) PCT No.: PCT/FR11/00653

§ 371 Date: Oct. 8, 2013

(30) Foreign Application Priority Data
Dec. 22, 2010 (FR) 1005029

(51) Int. Cl. B01J 29/48; B01J 23/888; C10G 65/12; B01J 23/882

(52) U.S. Cl. CPC B01J 29/48; B01J 23/882; B01J 23/888; C10G 65/12
USPC 208/89; 502/242; 502/255; 502/254; 502/74

(57) ABSTRACT

An inorganic material is described, constituted by at least two elementary spherical particles, each of said spherical particles comprising metallic nanoparticles having at least one band with a wave number in the range 750 to 1050 cm⁻¹ in Raman spectroscopy and containing one or more metals selected from vanadium, niobium, tantalum, molybdenum and tungsten, said metallic nanoparticles being trapped in a mesostructured matrix based on an oxide of an element Y selected from silicon, aluminium, titanium, tungsten, zirconium, gallium, germanium, tin, antimony, lead, vanadium, iron, manganese, hafnium, niobium, tantalum, yttrium, cerium, gadolinium, europium and neodymium. Said matrix has pores with a diameter in the range 1.5 to 50 nm and amorphous walls with a thickness in the range 1 to 30 nm. Said elementary spherical particles have a maximum diameter of 200 microns and said metallic nanoparticles have a maximum dimension strictly less than 1 nm.

The present invention relates to the field of inorganic oxide materials, in particular to those containing transition metals, having an organized and uniform porosity in the mesopore domain. It also relates to the preparation of these materials which are obtained using the “aerosol” synthesis technique. It also relates to the use of these materials, following sulphurization, as catalysts in various processes relating to the fields of hydrotreatment, hydroconversion and the production of hydrocarbon feeds.

### PRIOR ART

The composition and use of catalysts for the hydroconversion (HDC) and hydrotreatment (HDT) of hydrocarbon feeds are respectively described in the work “Hydrocracking Science and Technology”, 1996, J. Scherzer, A. J. Gruia, Marcel Dekker Inc and in the article by B. S Clausen, H. T. Topsøe, F. E. Massoth, from the work “Catalysis Science and Technology”, 1996, volume 11, Springer-Verlag. Thus, those catalysts are generally characterized by a hydrodehydrogenating function provided by the presence of an active phase based on at least one metal from group VIB and/or at least one metal from group VB and optionally at least one metal from group VIII of the periodic table of the elements. The most usual formulations are of the cobalt-molybdenum (CoMo), nickel-molybdenum (NiMo) and nickel-tungsten (NiW) type. Such catalysts may be in the bulk form or in the supported state, which then uses a porous solid. After preparation, at least one metal from group VIB and/or at least one metal from group VB and optionally at least one metal from group VIII present in the catalytic composition of said catalysts are usually in the oxide form. The active and stable form for HDC and HDT processes is the sulphurized form, and so such catalysts undergo a sulphurization step.

The skilled person is generally aware that good catalytic performances in the fields of application mentioned above are a function of 1) the nature of the hydrocarbon feed to be treated, 2) the process used, 3) the functional operating conditions selected, and 4) the catalyst used. In this latter case, it is also known that a catalyst with a high catalytic potential is characterized by 1) an optimized hydrodehydrogenating function (associated active phase completely dispersed at the surface of the support and having a high metal content) and 2) in the particular case of processes using hydroconversion reactions (HDC), by a good balance between said hydrodehydrogenating function and the cracking function provided by the acid function of a support. In general, irrespective of the nature of the hydrocarbon feed to be treated, the reagents and reaction products should also have satisfactory access to the active sites of the catalyst which should also have a large active surface area, which means that specific constraints arise in terms of the structure and texture of the oxide support present in said catalysts. This latter point is particularly critical in the case of the treatment of “heavy” hydrocarbon feeds.

The usual methods leading to the formation of the hydrodehydrogenating phase of HDC and HDT catalysts consist in depositing molecular precursor(s) of at least one group VIB metal and/or at least one metal from group VB and optionally at least one metal from group VIII on an oxide support using the technique known as “dry impregnation”, followed by steps for maturation, drying and calcining, resulting in the formation of the oxidized form of said metal(s) employed. Next, a final step for sulphurizing, generating the active hydrodehydrogenating phase, is carried out as mentioned above.

The catalytic performances of the catalysts obtained using such conventional synthesis protocols have been studied in depth. In particular, it has been shown that for relatively high metal contents, phases appear which are refractory to sulphurization, formed as a consequence of the calcining step (sintering phenomenon) (B. S. Clausen, H. T. Topsøe, and F. E. Massoth, from the work “Catalysis Science and Technology”, 1996, volume 11, Springer-Verlag). As an example, in the case of catalysts of the CoMo or NiMo type supported on an alumina type support, these are 1) crystallites of MoO₃, NiO, CoO, CoMoO₄ or Co₃O₄, of a size sufficient to be detected in XRD, and/or 2) species of the Al₂(MoO₄)₃, CoAl₂O₄ or NiAl₂O₄ type. The three species cited above containing the element aluminium are well known to the skilled person. They result from the interaction between the alumina support and precursor salts of the active hydrodehydrogenating phase in solution, which in practice results in a reaction between Al³⁺ ions extracted from the alumina matrix and said salts in order to form Anderson heteropolyanions with formula [Al(OH)₆Mo₆O₁₈]³⁻, which are themselves precursors of phases which are refractory to sulphurization. The presence of all of these species results in a non-negligible indirect loss of catalytic activity of the associated catalyst because not all of the elements belonging to at least one metal from group VIB and/or at least one metal from group VB and optionally at least one metal from group VIII are used to their maximum potential, since a portion thereof is immobilized in low activity or inactive species.

The catalytic performances of the conventional catalysts described above could thus be improved, in particular by developing novel methods for the preparation of these catalysts which could be used to:
1) ensure good dispersion of the hydrodehydrogenating phase, in particular for high metal contents (for example by controlling the size of the particles based on transition metals, maintaining the properties of those particles after heat treatment, etc.);
2) limit the formation of species which are refractory to sulphurization (for example by obtaining a better synergy between the transition metals forming the active phase, controlling the interactions between the hydrodehydrogenating active phase (and/or its precursors) and the porous support employed, etc.);
3) ensure good diffusion of reagents and reaction products while keeping the developed active surface areas high (optimization of chemical, textural and structural properties of the porous support).

In order to satisfy the needs expressed above, hydroconversion and hydrotreatment catalysts have been developed wherein the precursors of the active hydrodehydrogenating phase are formed from heteropolyanions (HPA), for example heteropolyanions based on cobalt and molybdenum (CoMo systems), nickel and molybdenum (NiMo systems), nickel and tungsten (NiW), nickel, vanadium and molybdenum (NiMoV systems) or phosphorus and molybdenum (PMo). As an example, patent application FR 2.843.050 discloses a hydrorefining and/or hydroconversion catalyst comprising at least one element from group VIII and at least molybdenum and/or tungsten present in the oxide precursor at least partially in the form of heteropolyanions. In general, the heteropolyanions are impregnated onto an oxide support.

About a decade ago, other catalysts with supports which have a controlled hierarchical porosity were developed. In the context of applications pertaining to the fields of hydrotreatment, hydroconversion and the production of hydrocarbon feeds, apart from the accessibility (linked to pore size)/developed active surface (linked to the specific surface area) compromise, control of which is desirable, it is important to control parameters such as the pore length, the tortuosity or the connectivity between the pores (defined by the access number of each cavity). The structural properties linked to a periodic arrangement and to a particular morphology of the pores are parameters which are essential to control. As an example, US patent 2007/152181 teaches that for the transformation of various oil cuts, it is advantageous to use mesostructured alumina type catalyst supports developing a large specific surface area and a homogeneous pore size distribution. French patent application FR 2.834.978 also discloses that incorporating metallic particles into the walls of a mesostructured solid endows those particles with enhanced thermal resistance to sintering (dispersion of starting particles is maintained).

### SUMMARY OF THE INVENTION

The present invention concerns an inorganic material constituted by at least two elementary spherical particles, each of said spherical particles comprising metallic nanoparticles having at least one band with a wave number in the range 750 to 1050 cm⁻¹ in Raman spectroscopy and containing at least one or more metals selected from vanadium, niobium, tantalum, molybdenum and tungsten, said metallic nanoparticles being present within a mesostructured matrix based on an oxide of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, said matrix having pores with a diameter in the range 1.5 to 50 nm and having amorphous walls with a thickness in the range 1 to 30 nm, said elementary spherical particles having a maximum diameter of 200 microns and said metallic nanoparticles having a maximum dimension strictly less than 1 nm.

The material of the invention is prepared using a particular synthesis technique known as an “aerosol” technique.

After sulphurization, the mesostructured inorganic material of the invention is used as a catalyst in various processes for the transformation of hydrocarbon feeds, in particular in catalytic processes involving hydrotreatment and/or hydroconversion of hydrocarbon feeds in the refining field.

### INTEREST OF THE INVENTION

The material of the invention comprising metallic nanoparticles trapped in the mesostructured matrix of each of the elementary spherical particles constituting said material is an advantageous catalytic precursor. It simultaneously has properties germane to the presence of metallic nanoparticles, in particular better dispersion of the active phase, a better synergy between the hydrodehydrogenating sites and any acidic sites, a reduction in the phases refractory to sulphurization, and structural, textural and optionally acido-basic properties and redox properties that are specific to mesostructured materials based on the oxide of at least one element Y, in particular the non-limiting mass transfer of reagents and reaction products and the high active surface area value. The metallic nanoparticles are precursor species of the active sulphurized phase present in the catalyst obtained from the material of the invention after sulphurization.

The diffusion properties of the reagents and the reaction products associated with the inorganic material of the invention constituted by elementary spherical particles with a maximum diameter of 200 μm are enhanced with respect to those of other mesostructured materials which are known in the art and not obtained by the aerosol method and in the form of elementary particles which are not homogeneous in shape, i.e. irregular, and with a dimension of much more than 500 nm. In addition to the specific properties of metallic nanoparticles on the one hand, and of the mesostructured oxide matrix present in each of the spherical particles of the material of the invention on the other hand, trapping the metallic nanoparticles in the mesostructured oxide matrix generates additional favourable technical effects such as control over the size of said metallic nanoparticles, an increase in the thermal stability of said nanoparticles, and the development of original nanoparticle/support interactions.

In addition, the preparation process using the aerosol method of the invention can be used to easily produce a variety of precursors of sulphurized catalysts, in a single step (one pot), which are based on metallic nanoparticles.

In addition, compared with known syntheses of mesostructured materials which do not use the aerosol method, the preparation of the material of the invention is carried out continuously, the preparation period is reduced (a few hours as opposed to 12 to 24 hours using autoclaving) and the stoichiometry of the non-volatile species present in the initial solution of the reagents is maintained in the material of the invention.

### SUMMARY OF THE INVENTION

The present invention concerns an inorganic material constituted by at least two elementary spherical particles, each of said spherical particles comprising metallic nanoparticles having at least one band with a wave number in the range 750 to 1050 cm⁻¹ in Raman spectroscopy and containing at least one or more metals selected from vanadium, niobium, tantalum, molybdenum and tungsten, said metallic nanoparticles being present within a mesostructured matrix based on an oxide of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, said matrix having pores with a diameter in the range 1.5 to 50 nm and having amorphous walls with a thickness in the range 1 to 30 nm, said elementary spherical particles having a maximum diameter of 200 microns and said metallic nanoparticles having a maximum dimension strictly less than 1 nm.

In accordance with the invention, the element Y present in the form of an oxide in the mesostructured matrix included in each of said spherical particles of the material of the invention is selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements and preferably, said element Y present in the oxide form is selected from the group constituted by silicon, aluminium, titanium, zirconium, gallium, germanium and cerium and a mixture of at least two of these elements. Still more preferably, said element Y present in the oxide form is selected from the group constituted by silicon, aluminium, titanium, zirconium and a mixture of at least two of these elements. In accordance with the invention, said mesostructured matrix is preferably constituted by aluminium oxide, silicon oxide or a mixture of silicon oxide and aluminium oxide, or a mixture of silicon oxide and zirconium oxide. In the preferred case in which said mesostructured matrix is a mixture of silicon oxide and aluminium oxide (aluminosilicate), said matrix has a Si/Al molar ratio equal to at least 0.02, preferably in the range 0.1 to 1000 and highly preferably in the range 1 to 100.

Said matrix based on an oxide of at least said element Y is mesostructured: it has a porosity which is organized on the mesopore scale for each of the elementary particles of the material of the invention, i.e. an organized porosity on the pore scale with a uniform diameter in the range 1.5 to 50 nm, preferably in the range 1.5 to 30 nm, and still more preferably in the range 4 to 20 nm and distributed in a homogeneous and regular manner in each of said particles (mesostructuring of the matrix). The material located between the mesopores of the mesostructured matrix is amorphous and forms walls or partitions the thickness of which is in the range 1 to 30 nm, preferably in the range 1 to 10 nm. The thickness of the walls corresponds to the distance separating a first mesopore from a second mesopore, the second mesopore being the pore which is closest to said first mesopore. The organization of the mesoporosity as described above results in structuring of said matrix, which may be hexagonal, vermicular or cubic, preferably vermicular. The mesostructured matrix advantageously has no porosity in the micropore range.

The material of the invention also has an interparticulate textural macroporosity.

The mesostructured matrix comprised in each of said spherical particles of the material of the invention comprises metallic nanoparticles containing at least one or more metals M selected from vanadium, niobium, tantalum, molybdenum and tungsten and preferably containing molybdenum and/or tungsten. More precisely, said metallic nanoparticles are trapped in the mesostructured matrix. Said metal selected from vanadium, niobium, tantalum, molybdenum, tungsten and a mixture thereof, preferably molybdenum or tungsten, is in an oxygenated environment. Said metallic nanoparticles trapped in the mesostructured oxide matrix comprised in each of said spherical particles of the material of the invention advantageously have atoms M wherein the oxidation number is equal to +IV, +V and/or +VI. The metallic nanoparticles are trapped in the matrix in a homogeneous and uniform manner. Examples of said nanoparticles are monomolybdic species, monotungstic species, polymolybdic species or polytungstic species. Such species, in particular polymolybdate species, are described by S. B. Umbarkar et al., Journal of Molecular Catalysis A: Chemical, 310, 2009, 152. Advantageously, said mesostructured matrix comprises metallic nanoparticles based on a metal selected from vanadium, niobium, tantalum, molybdenum, tungsten and other nanoparticles based on another metal selected from vanadium, niobium, tantalum, molybdenum and tungsten. Highly advantageously, said mesostructured matrix comprises metallic nanoparticles based on molybdenum and other nanoparticles based on tungsten. Said metallic nanoparticles are prepared using protocols which are known to the skilled person, using precursors which are advantageously monometallic, such as those described below in the disclosure of the invention. They have a dimension strictly less than 1 nm. In particular, said metallic nanoparticles are not detected in transmission electron microscopy (TEM). In accordance with the invention, said spherical particles constituting the material of the invention are free of the presence of metallic particles in the form of heteropolyanions.

In accordance with the invention, said metallic nanoparticles are characterized by the presence of at least one band with a wave number in the range 750 to 1050 cm⁻¹ in Raman spectroscopy. Raman spectroscopy is a technique which is well known to the skilled person. More precisely, said metallic nanoparticles have at least one band with a wave number in the range 750 to 950 cm⁻¹ or in the range 950 to 1050 cm⁻¹. The band with a wave number in the range 750 to 950 cm⁻¹ is attributable to antisymmetric (M-O-M) bond stretching or to symmetric (—O-M-O—) bond stretching. The band with a wave number in the range 950 to 1050 cm⁻¹ is attributable to stretching modes of the terminal M=O bonds. The element M present in the M-O-M, —O-M-O— and M=O bonds is selected from vanadium, niobium, tantalum, molybdenum and tungsten and preferably from molybdenum and/or tungsten. The Raman apparatus used to identify said metallic nanoparticles is described below in the present description.

Said nanoparticles advantageously represent 4% to 50% by weight, preferably 5% to 40% by weight and highly preferably 6% to 30% by weight of the material of the invention.

The inorganic material in accordance with the invention comprises a quantity by weight of the element(s) vanadium, niobium, tantalum, molybdenum and tungsten in the range 1% to 40%, expressed as the % by weight of oxide with respect to the final mass of material in the oxide form, preferably in the range 4% to 35% by weight, more preferably in the range 4% to 30% and still more preferably in the range 4% to 20%.

In accordance with a first particular embodiment of the material in accordance with the invention, each of the spherical particles constituting said material further comprises zeolitic nanocrystals. Said zeolitic nanocrystals are trapped, with the metallic nanoparticles, in the mesostructured matrix contained in each of the elementary spherical particles. In accordance with this embodiment of the invention consisting of trapping zeolitic nanocrystals in the mesostructured matrix, the material of the invention has at the same time, in each of the elementary spherical particles, a mesoporosity in the matrix itself (mesopores with a uniform diameter in the range 1.5 to 50 nm, preferably in the range 1.5 to 30 nm and more preferably in the range 4 to 20 nm) and a zeolitic type microporosity generated by the zeolitic nanocrystals trapped in the mesostructured matrix. Said zeolitic nanocrystals have a pore size in the range 0.2 to 2 nm, preferably in the range 0.2 to 1 nm and more preferably in the range 0.2 to 0.8 nm. Said zeolitic nanocrystals advantageously represent 0.1% to 30% by weight, preferably 0.1% to 20% by weight and highly preferably 0.1% to 10% by weight of the material of the invention. The zeolitic nanocrystals have a maximum dimension, generally a maximum diameter, of 300 nm, and preferably have a dimension, generally a diameter, in the range 10 to 150 nm. Any zeolite, in particular but not in a restrictive manner those listed in the “Atlas of zeolite framework types”, 6^{th} revised Edition, 2007, Ch. Baerlocher, L. B. L. McCusker, D. H. Olson, may be employed in the zeolitic nanocrystals present in each of the elementary spherical particles constituting the material in accordance with the invention. The zeolitic nanocrystals preferably comprise at least one zeolite selected from the zeolites IZM-2, ZSM-5, ZSM-12, ZSM-48, ZSM-22, ZSM-23, ZBM-30, EU-2, EU-11, silicalite, beta, zeolite A, faujasite, Y, USY, VUSY, SDUSY, mordenite, NU-10, NU-87, NU-88, NU-86, NU-85, IM-5, IM-12, IM-16, ferrierite and EU-1. Highly preferably, the zeolitic nanocrystals comprise at least one zeolite selected from zeolites with structure type MFI, BEA, FAU and LTA. Nanocrystals of various zeolites and in particular of zeolites with a different structure type may be present in each of the spherical particles constituting the material in accordance with the invention. In particular, each of the spherical particles constituting the material in accordance with the invention may advantageously comprise at least first zeolitic nanocrystals wherein the zeolite is selected from the zeolites IZM-2, ZSM-5, ZSM-12, ZSM-48, ZSM-22, ZSM-23, ZBM-30, EU-2, EU-11, silicalite, beta, zeolite A, faujasite, Y, USY, VUSY, SDUSY, mordenite, NU-10, NU-87, NU-88, NU-86, NU-85, IM-5, IM-12, IM-16, ferrierite and EU-1, preferably from zeolites with structure type MFI, BEA, FAU and LTA, and at least second zeolitic nanocrystals wherein the zeolite differs from that of the first zeolitic nanocrystals and is selected from the zeolites IZM-2, ZSM-5, ZSM-12, ZSM-48, ZSM-22, ZSM-23, ZBM-30, EU-2, EU-11, silicalite, beta, zeolite A, faujasite, Y, USY, VUSY, SDUSY, mordenite, NU-10, NU-87, NU-88, NU-86, NU-85, IM-5, IM-12, IM-16, ferrierite and EU-1, preferably from zeolites with structure type MFI, BEA, FAU, and LTA. The zeolitic nanocrystals advantageously comprise at least one zeolite which is either entirely of silica or contains, in addition to silicon, at least one element T selected from aluminium, iron, boron, indium, gallium and germanium, preferably aluminium.

In accordance with a second particular embodiment of the material in accordance with the invention, which may or may not be independent of said first embodiment described above, each of the spherical particles constituting said material further comprises one or more additional element(s) selected from organic agents, metals from group VIII of the periodic classification of the elements and doping species belonging to the list of doping elements constituted by phosphorus, fluorine, silicon and boron and their mixtures. Said metal(s) from group VIII as an additional element is (are) advantageously selected from cobalt, nickel and a mixture of these two metals. The inorganic material of the invention comprises an overall quantity by weight of metal or metals from group VIII, in particular nickel and/or cobalt, in the range 0 to 15%, expressed as the % by weight of oxide with respect to the final mass of the material in the oxide form, preferably in the range 0.5% to 10% by weight and still more preferably in the range 1% to 8% by weight. The total quantity of the doping species (P, F, Si, B and mixtures thereof) is in the range 0.1% to 10% by weight, preferably in the range 0.5% to 8% by weight, and still more preferably in the range 0.5% to 6% by weight, expressed as the % by weight of oxide, with respect to the weight of mesostructured inorganic material of the invention. The atomic ratio between the doping species and the metal(s) selected from V, Nb, Ta, Mo and W is preferably in the range 0.05 to 0.9, more preferably in the range 0.08 to 0.8, the doping species and the metal(s) selected from V, Nb, Ta, Mo and W taken into account for the calculation of this ratio corresponding to the total content in the material of the invention of doping species and of metal(s) selected from V, Nb, Ta, Mo and W.

In accordance with the invention, said elementary spherical particles constituting the material in accordance with the invention have a maximum diameter equal to 200 μm, preferably less than 100 μm, advantageously in the range 50 nm to 50 μm, highly advantageously in the range 50 nm to 30 μm and still more advantageously in the range 50 nm to 10 μm. More precisely, they are present in the material in accordance with the invention in the form of powder, beads, pellets, granules, extrudates (cylinders which may or may not be hollow, multilobed cylinders, for example with 2, 3, 4 or 5 lobes, or twisted cylinders) or rings. The material in accordance with the invention advantageously has a specific surface area in the range 50 to 1100 m²/g, highly advantageously in the range 50 to 600 m²/g and still more preferably in the range 50 to 400 m²/g.

The present invention also pertains to a process for the preparation of the material in accordance with the invention.

Said preparation process in accordance with the invention comprises at least the following steps in succession:

a) mixing in solution:
at least one surfactant;
at least one precursor of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements;
at least one first metallic precursor containing at least one or more metals selected from vanadium, niobium, tantalum, molybdenum and tungsten present in metallic nanoparticles having at least one band with a wave number in the range 750 to 1050 cm⁻¹ in Raman spectroscopy;
optionally, at least one colloidal solution in which zeolite crystals with a maximum nanometric dimension equal to 300 nm are dispersed;
   b) aerosol atomisation of said solution obtained in step a) in order to result in the formation of spherical liquid droplets; c) drying said droplets; d) eliminating at least said surfactant in order to obtain said mesostructured inorganic material in which said metallic nanoparticles are trapped.

In accordance with the preparation process of the invention, said nanoparticles are preferably prepared by dissolving, prior to said step b), the necessary metallic precursor(s), namely at least said first metallic precursor, said solution then being introduced into the mixture of said step a). Preferably, the solvent used to dissolve the precursor or precursors is aqueous and the solution obtained after dissolving the metallic precursor(s) prior to step a) containing said precursors is clear and the pH is neutral, basic or acidic, preferably acidic. Said first metallic precursor employed is advantageously a monometallic precursor. Preferably, said first monometallic precursor is based on molybdenum or tungsten. It is advantageous to use at least two metallic precursors, each of said precursors being based on a different metal selected from vanadium, niobium, tantalum, molybdenum and tungsten. Thus, an inorganic mesostructured material is obtained in which the nanoparticles based on a metal selected from vanadium, niobium, tantalum, molybdenum and tungsten and other nanoparticles based on another metal selected from vanadium, niobium, tantalum, molybdenum and tungsten are trapped in the matrix. As an example, a precursor based on molybdenum and a precursor based on tungsten are advantageously used so as to trap the nanoparticles based on molybdenum and nanoparticles based on tungsten in the matrix.

In the preferred case in which said nanoparticles comprise tungsten and/or molybdenum, said first monometallic precursor formed from one of the following species is advantageously used in the process of the invention: species of the alcoholate or phenolate type (W—O bond, Mo—O bond), species of the amide type (W—NR₂ bond, Mo—NR₂ bond), species of the halide type (W—Cl bond, Mo—Cl bond, for example), species of the imido type (W═N—R bond, Mo═N—R bond), species of the oxo type (W═O bond, Mo═O bond), species of the hydride type (W—H bond, Mo—H bond). Advantageously, said first monometallic precursor is selected from the following species: (NH₄)₂MO₄ (M=Mo, W), Na₂MO₄ (M=Mo, W), H₂MoO₄, (NH₄)₂MS₄ (M=Mo, W), MoO₂Cl₂, MoCl₄, MoCl₅, W(OEt)₅, W(Et)₆, WCl₆, WCl₄, WCl₂, and WPhCl₃. However, any monometallic precursor which is familiar to the skilled person may be employed.

In accordance with step a) of the process for the preparation of the mesostructured inorganic material in accordance with the invention, the precursor(s) of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, preferably selected from the group constituted by silicon, aluminium, titanium, zirconium, gallium, germanium and cerium and a mixture of at least two of these elements is(are) inorganic oxide precursor(s) which are well known to the skilled person. The precursor(s) of at least said element Y may be any compound comprising the element Y and capable of liberating that element in solution, for example in aquo-organic solution, preferably in aquo-organic acid solution, in a reactive form. In the preferred case in which Y is selected from the group constituted by silicon, aluminium, titanium, zirconium, gallium, germanium and cerium and a mixture of at least two of these elements, the precursor(s) of at least said element Y is(are) advantageously an inorganic salt of said element Y with formula YZₙ, (n=3 or 4), Z being a halogen, the group NO₃ or a perchlorate; preferably, Z is chlorine. The precursor(s) of at least said element Y under consideration may also be (an) alkoxide precursor(s) with formula Y(OR)ₙ where R=ethyl, isopropyl, n-butyl, s-butyl, t-butyl, etc. or a chelated precursor such as Y(C₅H₈O₂)ₙ, with n=3 or 4. The precursor(s) of at least said element Y under consideration may also be (an) oxide(s) or (a) hydroxide(s) of said element Y. Depending on the nature of the element Y, the precursor of the element Y under consideration may also be in the form YOZ₂, Z being a monovalent anion such as a halogen, or the group NO₃. Preferably, said element(s) Y is(are) selected from the group constituted by silicon, aluminium, titanium, zirconium, gallium, germanium and cerium and a mixture of at least two of these elements. Highly preferably, the mesostructured oxide matrix comprises, preferably is constituted by, aluminium oxide, silicon oxide (Y=Si or Al) or comprises, preferably is constituted by, a mixture of silicon oxide and aluminium oxide (Y=Si+Al) or a mixture of silicon oxide and zirconium oxide (Y=Si+Zr). In the particular case in which Y is silicon or aluminium or a mixture of silicon and aluminium or a mixture of silicon and zirconium, the silica and/or alumina precursors and the zirconium precursors used in step a) of the process for the preparation of the material in accordance with the invention are inorganic oxide precursors which are well known to the skilled person. The silica precursor is obtained from any source of silica, advantageously from a sodium silicate precursor with formula Na₂SiO₃, a chlorinated precursor with formula SiCl₄, an alkoxide precursor with formula Si(OR)₄ where R═H, methyl or ethyl, or a chloralkoxide precursor with formula Si(OR)₄₋ₐClₐ where R═H, methyl or ethyl, a being in the range 0 and 4. The silica precursor may also advantageously be an alkoxide precursor with formula Si(OR)₄₋ₐR′ₐ where R═H, methyl or ethyl and R′ is an alkyl chain or a functionalized alkyl chain, for example by a thiol, amino, β-diketone or sulphonic acid group, a being in the range 0 to 4. A preferred silica precursor is tetraethylorthosilicate (TEOS). The alumina precursor is advantageously an inorganic salt of aluminium with formula AlZ₃, Z being a halogen or the group NO₃. Preferably, Z is chlorine. The alumina precursor may also be an alkoxide precursor with formula Al(OR″)₃ where R″=ethyl, isopropyl, n-butyl, s-butyl or t-butyl, or a chelated precursor such as aluminium acetylacetonate (Al(CH₇O₂)₃). The alumina precursor may also be an oxide or an aluminium hydroxide.

The surfactant used for the preparation of the mixture in accordance with step a) of the process for the preparation of the material in accordance with the invention is an ionic or non-ionic surfactant or a mixture of the two. Preferably, the ionic surfactant is selected from phosphonium and ammonium ions, and highly preferably from quaternary ammonium salts such as cetyltrimethylammonium bromide (CTAB). Preferably, the non-ionic surfactant may be any copolymer having at least two portions with different polarities, endowing them with amphiphilic macromolecular properties. These copolymers may comprise at least one block forming part of the following non-exhaustive list of polymer families: fluorinated polymers (—[CH₂—CH₂—CH₂—CH₂—O—CO—R1-, in which R1=C₄F₉, C₈F₁₇, etc.), biological polymers such as polyamino acids (poly-lysine, alginates, etc.), dendrimers, polymers constituted by chains of poly(alkylene oxide). In general, any copolymer with an amphiphilic nature which is known to the skilled person may be used (S. Förster, M. Antionnetti, Adv. Mater, 1998, 10, 195-217; S. Förster, T. Plantenberg, Angew. Chem. Int. Ed, 2002, 41, 688-714; H. Cölfen, Macromol. Rapid Commun, 2001, 22, 219). Preferably, in the context of the present invention, a block copolymer is used which is constituted by chains of poly(alkylene oxide). Said block copolymer is preferably a block copolymer containing two, three or four blocks, each block being constituted by one chain of poly(alkylene oxide). For a two-block copolymer, one of the blocks is constituted by a chain of poly(alkylene oxide) with a hydrophilic nature and the other block is constituted by a poly(alkylene oxide) chain with a hydrophobic nature. For a three-block copolymer, at least one of the blocks is constituted by a poly(alkylene oxide) chain with a hydrophilic nature, while at least one of the other blocks is constituted by a poly(alkylene oxide) chain with a hydrophobic nature. Preferably, in the case of a three-block copolymer, the poly(alkylene oxide) chains with a hydrophilic nature are chains of poly(ethylene oxide) denoted (PEO)_{w} and (PEO)_{z} and the chains of poly(alkylene oxide) with a hydrophobic nature are chains of poly(propylene oxide) denoted (PPO)_{y}, chains of poly(butylene oxide), or mixed chains wherein each chain is a mixture of several alkylene oxide monomers. Highly preferably, in the case of a three-block copolymer, a compound with formula (PEO)_{w}—(PPO)_{y}—(PEO)_{z} is used, where w is in the range 5 to 300, y is in the range 33 to 300 and z is in the range 5 to 300. Preferably, the values for w and z are identical. Highly advantageously, a compound in which w=20, y=70 and z=20 (P123) is used and a compound in which w=106, y=70 and z=106 (F127) is used. Commercially available non-ionic surfactants with the names Pluronic (BASF), Tetronic (BASF), Triton (Sigma), Tergitol (Union Carbide), Brij (Aldrich) may be used as non-ionic surfactants. For a four-block copolymer, two of the blocks are constituted by a chain of poly(alkylene oxide) with a hydrophilic nature and the other two blocks are constituted by a chain of poly(alkylene oxide) with a hydrophobic nature. Preferably, to prepare the mixture in accordance with step a) of the process for the preparation of the material of the invention, a mixture of an ionic surfactant such as CTAB and a non-ionic surfactant such as P123 or F127 is used.

In step a) of the preparation process in accordance with the invention, the colloidal solution in which the zeolite crystals with a maximum nanometric dimension equal to 300 nm are dispersed, optionally added to the mixture envisaged in said step a), is obtained either by prior synthesis, in the presence of a template, of zeolitic nanocrystals with a maximum nanometric dimension of 300 nm, or by using zeolitic crystals which have the ability to disperse in the form of nanocrystals with a maximum nanometric dimension equal to 300 nm in solution, for example in acidic aquo-organic solution. In the first variation consisting of prior synthesis of the zeolitic nanocrystals, these are synthesized using operating protocols which are known to the skilled person. In particular, the synthesis of beta zeolite nanocrystals has been described by T. Bein et al., Micropor. Mesopor. Mater., 2003, 64, 165. The synthesis of nanocrystals of Y zeolite has been described by T. J. Pinnavaia et al., J. Am. Chem. Soc., 2000, 122, 8791. The synthesis of nanocrystals of faujasite zeolite has been described by Kloetstra et al., Microporous Mater., 1996, 6, 287. The synthesis of nanocrystals of ZSM-5 zeolite has been described by R. Mokaya et al., J. Mater. Chem., 2004, 14, 863. The synthesis of nanocrystals of silicalite (or structure type MFI) has been described in a number of publications: R. de Ruiter et al., Synthesis of Microporous Materials, Vol. I; M. L. Occelli, H. E. Robson (eds.), Van Nostrand Reinhold, New York, 1992, 167; A. E. Persson, B. J. Schoeman, J. Sterte, J.-E. Otterstedt, Zeolites, 1995, 15, 611. In general, the zeolitic nanocrystals are synthesised by preparing a reaction mixture comprising at least one source of silica, optionally at least one source of at least one element T selected from aluminium, iron, boron, indium, gallium and germanium, preferably at least one source of alumina, and at least one template. The reaction mixture for the synthesis of the zeolitic nanocrystals is either aqueous or aquo-organic, for example a water-alcohol mixture. The reaction mixture is advantageously used under hydrothermal conditions under autogenic pressure, optionally by adding a gas, for example nitrogen, at a temperature in the range 50° C. to 200° C., preferably in the range 60° C. to 170° C. and more preferably at a temperature which does not exceed 120° C. until the zeolitic nanocrystals are formed. At the end of said hydrothermal treatment, a colloidal solution is obtained in which the nanocrystals are in the dispersed state. The template may be ionic or neutral, depending on the zeolite to be synthesized. It is usual to use templates from the following non-exhaustive list: nitrogen-containing organic cations, elements from the alkali family (Cs, K, Na, etc.), crown ethers, diamines as well as any other template which is well known to the skilled person. In the second variation consisting of using zeolitic crystals directly, these are synthesised by methods which are known to the skilled person. Said zeolitic crystals may already be in the form of nanocrystals. In addition, zeolitic crystals with a dimension of more than 300 nm, for example in the range 300 nm to 200 μm, may advantageously be used; they disperse in solution, for example in an aquo-organic solution, preferably in acidic aquo-organic solution, in the form of nanocrystals with a maximum nanometric dimension of 300 nm. Obtaining zeolitic crystals which disperse in the form of nanocrystals with a maximum nanometric dimension of 300 nm is also possible by functionalizing the surface of the nanocrystals. The zeolitic crystals used are either in their as-synthesized form, i.e. still containing template, or in their calcined form, i.e. free of said template. When the zeolitic crystals used are in their as-synthesized form, said template is eliminated during step d) of the preparation process of the invention.

The solution in which at least one surfactant, at least one precursor of at least one element Y, at least said first metallic precursor, optionally at least said second metallic precursor, and optionally at least one stable colloidal solution in which zeolite crystals with a maximum nanometric dimension of 300 nm are dispersed are mixed in accordance with step a) of the process for the preparation of the material of the invention may be acidic, neutral or basic. Preferably, said solution is acidic and has a maximum pH of 3, preferably in the range 0 to 2. Non-exhaustive examples of acids which may be used to obtain an acidic solution are hydrochloric acid, sulphuric acid and nitric acid. Said solution in accordance with said step a) may be aqueous or it may be a water-organic solvent mixture, the organic solvent preferably being a polar solvent which is miscible with water, in particular an alcohol, preferably ethanol. Said solution in accordance with said step a) of the preparation process of the invention may also be practically organic, preferably practically alcoholic, the quantity of water being such that hydrolysis of the inorganic precursors is ensured (stoichiometric quantity). Highly preferably, said solution in said step a) of the preparation process of the invention in which at least one surfactant, at least one precursor of at least one element Y, at least said metallic precursor, optionally at least said second metallic precursor and optionally at least one stable colloidal solution in which zeolite crystals with a maximum nanometric dimension of 300 nm are dispersed are mixed is an acidic aquo-organic mixture, highly preferably a water-alcohol acidic mixture.

The quantity of zeolitic nanocrystals dispersed in the colloidal solution, obtained in accordance with this variation by prior synthesis, in the presence of a template, of zeolitic nanocrystals with a maximum nanometric dimension of 300 nm or in the variation using zeolitic crystals which have the property of dispersing in the form of nanocrystals with a maximum nanometric dimension of 300 nm in solution, for example in acidic aquo-organic solution, optionally introduced during step a) of the preparation process of the invention, is such that the zeolitic nanocrystals advantageously represent 0.1% to 30% by weight, preferably 0.1% to 20% by weight and highly preferably 0.1% to 10% by weight of the material of the invention.

The quantity of metallic nanoparticles as described above in the present description is such that said nanoparticles advantageously represent 4% to 50% by weight, preferably 5% to 40% by weight and more preferably 6% to 30% by weight of the material of the invention.

The initial concentration of surfactant introduced into the mixture in accordance with said step a) of the preparation process of the invention is defined by c₀, and c₀ is defined with respect to the critical micellar concentration (c_{mc}) which is familiar to the skilled person. The c_{mc} is the limiting concentration beyond which the phenomenon of self-assembly of molecules of surfactant occurs in the solution. The concentration c₀ may be lower than, equal to or higher than c_{mc}; preferably, it is lower than the c_{mc}. In a preferred implementation of the process for the preparation of the material of the invention, the concentration c₀ is less than c_{mc} and said solution envisaged in step a) of said preparation process of the invention is an acidic water-alcohol mixture. In the case in which the solution envisaged in step a) of the preparation process of the invention is a water-organic solvent mixture, preferably acidic, during said step a) of the preparation process of the invention, the concentration of surfactant at the origin of the mesostructuring of the matrix should preferably be lower than the critical micellar concentration so that evaporation of said aquo-organic solution, preferably acidic, during step b) of the preparation process of the invention by the aerosol technique causes a phenomenon of micellization or self-assembly, resulting in mesostructuring of the matrix of the material of the invention around said metallic nanoparticles and optional zeolitic nanocrystals which themselves remain unchanged in their shape and dimensions during steps b) and c) of the preparation process of the invention. When c₀<c_{mc}, mesostructuring of the matrix of the material of the invention prepared using the process described above is consecutive to a gradual concentration, in each droplet, of at least the precursor of said element Y and the surfactant, up to a concentration of surfactant of c>c_{mc} resulting from evaporation of the aquo-organic solution, preferably acidic.

In general, the increase in the joint concentration of at least one precursor of said hydrolysed element Y and the surfactant causes precipitation of at least said hydrolysed precursor of said element Y around the self-organized surfactant and as a consequence, structuring of the matrix of the material of the invention. The mutual interactions of the inorganic species, the organic/inorganic phases and the mutual interaction of the organic species result, via a cooperative self-assembly mechanism, in condensation of at least said precursor of said hydrolysed element Y about the self-organized surfactant. During this self-assembly phenomenon, said metallic nanoparticles and optional zeolitic nanocrystals become trapped in said mesostructured matrix based on an oxide of at least said element Y included in each of the elementary spherical particles constituting the material of the invention.

The aerosol technique is particularly advantageous for carrying out said step b) of the preparation process of the invention so as to constrain the reagents present in the initial solution to interact together; loss of material apart from solvents, i.e. the solution, preferably the aqueous solution, preferably acidic, and optionally supplemented with a polar solvent, is not possible, and so the totality of said element(s) Y, said metallic nanoparticles and optional zeolitic nanocrystals initially present are completely conserved throughout the preparation process of the invention, instead of potentially being eliminated during filtration and washing steps encountered in conventional synthesis processes which are known to the skilled person.

The atomization step of the solution of said step b) of the preparation process of the invention produces spherical droplets. The size distribution of these droplets is of the log normal type. The aerosol generator used in the context of the present invention is a commercial model 9306A apparatus provided by TSI which has a 6-jet atomizer. Atomization of the solution is carried out in a chamber into which a vector gas, preferably an O₂/N₂ mixture (dry air), is fed under a pressure P equal to 1.5 bars. The diameter of the droplets varies as a function of the aerosol apparatus employed. In general, the diameter of the droplets is in the range 150 nm to 600 μm.

In accordance with step c) of the preparation process of the invention, said droplets are then dried. Drying is carried out by transporting said droplets via the vector gas, preferably the O₂/N₂ mixture, in PVC tubes, which results in gradual evaporation of the solution, for example the acidic aquo-organic solution obtained during said step a), and thus to the production of elementary spherical particles. Said drying is completed by passing said particles into an oven the temperature of which can be adjusted, the normal temperature range being from 50° C. to 600° C., preferably 80° C. to 400° C., the residence time of these particles in the oven being of the order of one second. The particles are then collected on a filter. A pump placed at the end of the circuit encourages the species to be channelled into the experimental aerosol device. Drying the droplets in step c) of the preparation process of the invention is advantageously followed by passage through the oven at a temperature in the range 50° C. to 150° C. In accordance with step d) of the preparation process of the invention, the elimination of the surfactant and optional template introduced in said step a) of the preparation process of the invention and used to synthesise said zeolitic nanocrystals is advantageously carried out by heat treatment, preferably by calcining in air (optionally enriched in O₂) in a temperature range of 300° C. to 1000° C., more precisely in a range of 500° C. to 600° C. for a period of 1 to 24 hours, preferably for a period of 3 to 15 hours.

In accordance with a first particular implementation of the process for the preparation of the material of the invention, at least one sulphur-containing compound is introduced into the mixture of said step a) or after carrying out said step d) in order to obtain the mesostructured inorganic material of the invention, at least in part but not completely in the sulphide form. Said sulphur-containing compound is selected from compounds containing at least one sulphur atom which will decompose at low temperatures (80-90° C.) to cause the formation of H₂S. As an example, said sulphur-containing compound is thiourea or thioacetamide. In accordance with said first particular implementation, sulphurization of said material of the invention is partial such that the presence of sulphur in said mesostructured inorganic material does not totally affect the presence of said metallic nanoparticles

The mesostructured inorganic material of the invention constituted by elementary spherical particles comprising metallic particles trapped in a mesostructured matrix based on an oxide of at least one element Y may be formed into the form of a powder, beads, pellets, granules, extrudates (cylinders which may or may not be hollow, multilobed cylinders with 2, 3, 4 or 5 lobes for example, twisted cylinders), or rings, etc., these shaping operations being carried out using conventional techniques which are known to the skilled person. Preferably, the material of the invention is obtained in the form of a powder, which is constituted by elementary spherical particles with a maximum diameter of 200 μm.

The operation for shaping the mesostructured inorganic material of the invention consists of mixing said mesostructured material with at least one porous oxide material which acts as a binder. Said porous oxide material is preferably a porous oxide material selected from the group formed by alumina, silica, silica-alumina, magnesia, clays, titanium oxide, zirconium oxide, lanthanum oxide, cerium oxide, aluminium phosphates, boron phosphates and a mixture of at least two of the oxides cited above. Said porous oxide material may also be selected from alumina-boron oxide, alumina-titanium oxide, alumina-zirconia and titanium oxide-zirconia mixtures. The aluminates, for example magnesium, calcium, barium, manganese, iron, cobalt, nickel, copper or zinc aluminates, as well as mixed aluminates, for example those containing at least two of the metals cited above, are advantageously used as the porous oxide material. It is also possible to use titanates, for example zinc, nickel, or cobalt titanates. It is also advantageously possible to use mixtures of alumina and silica and mixtures of alumina with other compounds such as elements from group VIB, phosphorus, fluorine or boron. It is also possible to use simple, synthetic or natural clays of the dioctahedral 2:1 phyllosilicate or trioctahedral 3:1 phyllosilicate type such as kaolinite, antigorite, chrysotile, montmorillonnite, beidellite, vermiculite, talc, hectorite, saponite or laponite. These clays may optionally be delaminated. Advantageously, it is also possible to use mixtures of alumina and clay and mixtures of silica-alumina and clay. Similarly, using at least one compound as a binder selected from the group formed by the molecular sieve family of the crystalline aluminosilicate type and synthetic and natural zeolites such as Y zeolite, fluorinated Y zeolite, Y zeolite containing rare earths, X zeolite, L zeolite, beta zeolite, small pore mordenite, large pore mordenite, omega zeolites, NU-10, ZSM-22, NU-86, NU-87, NU-88, and ZSM-5 zeolite, may be envisaged. Of the zeolites, it is usually preferable to use zeolites with a framework silicon/aluminium (Si/Al) atomic ratio which is greater than approximately 3/1. Advantageously, zeolites with a faujasite structure are used, in particular stabilized and ultrastabilized (USY) Y zeolites either in the at least partially exchanged form with metallic cations, for example alkaline-earth metal cations and/or cations of rare earth metals with an atomic number of 57 to 71 inclusive, or in the hydrogen form (Atlas of zeolite framework types, 6^{th} revised Edition, 2007, Ch. Baerlocher, L. B. McCusker, D. H. Olson). Finally, it is possible to use, as the porous oxide material, at least one compound selected from the group formed by the family of non-crystalline aluminosilicate type molecular sieves such as mesosporous silicas, silicalite, silicoaluminophosphates, aluminophosphates, ferrosilicates, titanium silicoaluminates, borosilicates, chromosilicates and aluminophosphates of transition metals (including cobalt). The various mixtures using at least two of the compounds cited above are also suitable for use as a binder.

In a second particular implementation of the process for the preparation of the material of the invention, which may or may not be independent of said first implementation, one or more additional element(s) is introduced into the mixture of said step a) of the preparation process of the invention, and/or by impregnation of the material obtained from said step d) with a solution containing at least said additional element and/or by impregnation of the mesostructured material of the invention, which has already been shaped, with a solution containing at least said additional element. Said additional element is selected from metals from group VIII of the periodic classification of the elements, organic agents and doping species belonging to the list of doping elements constituted by phosphorus, fluorine, silicon and boron. In accordance with said second particular implementation, one or more additional element(s) as defined above is(are) introduced during the course of the process for the preparation of the material of the invention in one or more steps. In the case in which said additional element is introduced by impregnation, the dry impregnation method is preferred. Each impregnation step is advantageously followed by a drying step, for example carried out at a temperature in the range 90° C. to 200° C., said drying step preferably being followed by a step of calcining in air, optionally enriched in oxygen, for example carried out at a temperature in the range 200° C. to 600° C., preferably in the range 300° C. to 500° C., for a period in the range 1 to 12 hours, preferably in the range 2 to 6 hours. The techniques for impregnation, in particular dry impregnation, of a solid material with a liquid solution are well known to the skilled person. The doping species selected from phosphorus, fluorine, silicon and boron do not have any catalytic nature per se, but can be used to increase the catalytic activity of the metal(s) present in said metallic particles, in particular when the material is in the sulphurized form.

The sources of metals from group VIII used as precursors for said additional element based on at least one metal from group VIII are well known to the skilled person. Of the metals from group VIII, cobalt and nickel are preferred. As an example, nitrates will be used such as cobalt nitrate or nickel nitrate, sulphates, hydroxides such as cobalt hydroxides or nickel hydroxides, phosphates, halides (for example chlorides, bromides or fluorides) or carboxylates (for example acetates and carbonates). Preferably, said source of the metal from group VIII is used as a second monometallic precursor in said step a) of the preparation process of the invention. More particularly, at least said first metallic precursor, preferably at least said first monometallic precursor, based on a metal selected from vanadium, niobium, tantalum, molybdenum and tungsten and at least said second monometallic precursor based on a metal from group VIII preferably selected from nickel and cobalt are dissolved prior to carrying out said step a), said solution then being introduced into the mixture of said step a) of the preparation process in accordance with the invention. Advantageously, a first monometallic precursor based on molybdenum, for example MoCl₅, or on tungsten, for example WCl₄, and a second monometallic precursor based on nickel or cobalt, for example Ni(OH)₂ or Co(OH)₂, is used.

The source of boron used as a precursor for said doping species based on boron is preferably selected from acids containing boron, for example orthoboric acid H₃BO₃ and ammonium biborate, ammonium pentaborate, boron oxide and boric esters. In the case in which the source of boron is introduced by impregnation, said step for impregnation with the boron source is carried out using, for example, a solution of boric acid in a water/alcohol mixture or in a water/ethanolamine mixture. The source of boron may also be impregnated using a mixture formed by boric acid, hydrogen peroxide and a basic organic compound containing nitrogen, such as ammonia, primary and secondary amines, cyclic amines, compounds of the pyridine and quinolines family or compounds of the pyrrole family.

The source of phosphorus used as a precursor for said doping species based on phosphorus is preferably selected from orthophosphoric acid H₃PO₄, its salts and esters such as ammonium phosphates. In the case in which the phosphorus source is introduced by impregnation, said step for impregnation with the phosphorus source is carried out using, for example, a mixture formed by phosphoric acid and a basic organic compound containing nitrogen such as ammonia, primary and secondary amines, cyclic amines, compounds from the pyridine and quinoline family or compounds from the pyrrole family.

Many sources of silicon may be employed as precursors of said doping species based on silicon. Thus, it is possible to use ethyl orthosilicate Si(OEt)₄, siloxanes, polysiloxanes, silicones, silicone emulsions, or halosilicates such as ammonium fluorosilicate (NH₄)₂SiF₆ or sodium fluorosilicate Na₂SiF₆. In the case in which the source of silicon is introduced by impregnation, said impregnation step with the source of silicon is carried out using, for example, a solution of ethyl silicate in a water/alcohol mixture. The source of silicon may also be impregnated using a compound of silicon of the silicone type or silicic acid in suspension in water.

The sources of fluorine used as precursors for said doping species based on fluorine are well known to the skilled person. As an example, the fluoride anions may be introduced in the form of hydrofluoric acid or its salts. These salts are formed with alkali metals, ammonium or an organic compound. They are, for example, introduced during step a) of the process for the preparation of the material of the invention. In the case in which the source of fluorine is introduced by impregnation, said step for impregnation with the source of fluorine is carried out using, for example, an aqueous solution of hydrofluoric acid or ammonium fluoride or ammonium bifluoride.

The distribution and localisation of said doping species selected from boron, fluorine, silicon and phosphorus are advantageously determined using techniques such as the Castaing microprobe (distribution profile for the various elements), transmission electron microscopy coupled with X-ray analysis (i.e. EXD analysis which can be used to ascertain the qualitative and/or quantitative elemental composition of a sample from a measurement, using a Si(Li) diode, of the energies of X-ray photons emitted by the region of the sample bombarded by the electron beam) of the elements present in the mesostructured inorganic material of the invention, or by establishing a distribution map of the elements present in said material by electron microprobe. These techniques can be used to demonstrate the presence of these doping species. The analysis of the metals from group VIII and that of the organic species as the additional element are generally carried out by X-ray fluorescence elemental analysis.

Said doping species belonging to the list of doping elements constituted by phosphorus, fluorine, silicon, boron and a mixture of these elements is introduced in a quantity such that the total quantity of doping species is in the range 0.1% to 10% by weight, preferably in the range 0.5% to 8% by weight, and more preferably in the range 0.5% to 6% by weight, expressed as the % by weight of oxide, with respect to the weight of the mesostructured inorganic material of the invention. The atomic ratio between the doping species and the metal(s) selected from V, Nb, Ta, Mo and W is preferably in the range 0.05 to 0.9, still more preferably in the range 0.08 to 0.8, the doping species and the metal(s) selected from V, Nb, Ta, Mo and W taken into account for the calculation of this ratio corresponding to the total quantity, in the material of the invention, of doping species and of metal(s) selected from V, Nb, Ta, Mo and W independently of the mode of introduction.

The organic agents used as precursors of said additional element based on at least one organic agent are selected from organic agents which may or may not have chelating properties or reducing properties. Examples of said organic agents are mono-, di- or polyalcohols, which may be etherified, carboxylic acids, sugars, non-cyclic mono-, di- or polysaccharides such as glucose, fructose, maltose, lactose or sucrose, esters, ethers, crown ethers, compounds containing sulphur or nitrogen, such as nitriloacetic acid, ethylenediaminetetraacetic acid, or diethylenetriamine.

The present invention also concerns a process for the transformation of a hydrocarbon feed comprising 1) bringing a mesostructured inorganic material in accordance with the invention into contact with a feed comprising at least one sulphur-containing compound, then ii) bringing said material obtained from said step 2) into contact with said hydrocarbon feed.

In accordance with said step 1) of the transformation process of the invention, the metallic nanoparticles trapped in the mesostructured matrix of each of the spherical particles constituting the inorganic mesostructured material of the invention are sulphurized. The transformation of said metallic nanoparticles into their associated sulphurized active phase is carried out after heat treatment of said inorganic material of the invention in contact with hydrogen sulphide at a temperature in the range 200° C. to 600° C., more preferably in the range 300° C. to 500° C., using processes which are well known to the skilled person. More precisely, said sulphurization step 1) of the transformation process of the invention is carried out either directly in the reaction unit of said transformation process using a sulphur-containing feed in the presence of hydrogen and hydrogen sulphide (H₂S) introduced as is or obtained from the decomposition of an organic sulphur-containing compound (in situ sulphurization) or prior to charging said mesostructured inorganic material of the invention into the reaction unit for said transformation process (ex situ sulphurization). In the case of ex situ sulphurization, gaseous mixtures such as H₂/H₂S or N₂/H₂S are advantageously used to carry out said step 1). Said mesostructured inorganic material of the invention may also be sulphurized ex situ in accordance with said step 1) from molecules in the liquid phase, the sulphurizing agent then being selected from the following compounds: dimethyldisulphide (DMDS), dimethylsulphide, n-butylmercaptan, polysulphide compounds of the tertiononylpolysulphide type (for example TPS-37 or TPS-54 supplied by ATOFINA), these being diluted in an organic matrix composed of aromatic or alkyl molecules. Said sulphurization step 1) is preferably preceded by a step for heat treatment of said inorganic material of the invention using methods which are well known to the skilled person, preferably by calcining in air in a temperature range in the range 300° C. to 1000° C., and more precisely in the range 500° C. to 600° C., for a period of 1 to 24 hours, preferably for a period of 6 to 15 hours.

In accordance with the invention, said hydrocarbon feed which undergoes the transformation process of the invention comprises molecules containing at least hydrogen and carbon atoms in an amount such that said atoms represent at least 80% by weight, preferably at least 85% by weight of said feed. Said feed comprises molecules advantageously containing heteroelements, preferably selected from nitrogen, oxygen and/or sulphur, in addition to the hydrogen atoms and carbon atoms.

Various processes for the transformation of hydrocarbon feeds in which the inorganic material in the sulphurized form obtained from said step 1) is advantageously employed are, in particular hydrotreatment processes, more particularly hydrodesulphurization and hydrodenitrogenation processes, and hydroconversion processes, more particularly hydrocracking, of hydrocarbon feeds comprising saturated and unsaturated aliphatic hydrocarbons, aromatic hydrocarbons, organic oxygen-containing compounds and organic compounds containing nitrogen and/or sulphur as well as organic compounds containing other functional groups. More particularly, said inorganic material in the sulphurized form obtained from said step 1) is advantageously used in processes for the hydrotreatment of hydrocarbon feeds of the gasoline and middle distillate (gas oil and kerosene) type and processes for the hydroconversion and/or hydrotreatment of heavy hydrocarbon cuts such as vacuum distillates, deasphalted oils, atmospheric residues or vacuum residues. More advantageously, said inorganic material in the sulphurized form obtained from said step 1) is deployed in a process for the hydrotreatment of a hydrocarbon feed comprising triglycerides.

The mesostructured inorganic material in accordance with the invention constituted by elementary spherical particles comprising metallic nanoparticles trapped in a mesostructured oxide matrix having an organized and uniform porosity in the mesopore domain is characterized by a number of analytical techniques, in particular by small angle X-ray diffraction (small angle XRD), wide angle X-ray diffraction (XRD), nitrogen volumetric analysis (BET), transmission electron microscopy (TEM), scanning electron microscopy (SEM), and X-ray fluorescence (XRF). The presence of metallic particles as described above in the present description is demonstrated by various techniques, in particular by Raman, UV-visible or infrared spectroscopy, as well as by microanalysis. Nuclear magnetic spectroscopy (NMR), in particular ⁹⁵Mo and ¹⁸³W NMR, is also advantageously used to characterize the metallic nanoparticles.

The small angle X-ray diffraction technique (values for the angle 2θ in the range 0.5° to 5°) can be used to characterize the periodicity on a nanometric scale generated by the organized mesoporosity of the mesostructured matrix of the material of the invention. In the following discussion, the X-ray analysis is carried out on a powder with a diffractometer operating in reflection mode and provided with a back monochromator using the copper radiation line (wavelength 1.5406 Å). The peaks normally observed on the diffractograms corresponding to a given value of the angle 2θ are associated with the lattice spacings d₍ₕₖₗ₎ which are characteristic of the structural symmetry of the material ((hkl) being the Miller indices of the reciprocal lattice) by Bragg's law: 2d₍ₕₖₗ₎*sin(θ)=n*λ. This indexation then allows the lattice parameters (abc) of the direct lattice to be determined, the value of these parameters being a function of the hexagonal, cubic or vermicular structure obtained. By way of example, the small angle X-ray diffractogram of a mesostructured material of the invention constituted by elementary spherical particles comprising a mesostructured oxide matrix based on silicon and aluminium obtained using the preparation process of the invention via the use of a non-ionic surfactant, namely the copolymer F127, has a correlation peak which is completely resolved, corresponding to the correlation distance d between the pores which is characteristic of a vermicular structure and defined by Bragg's law : 2d₍ₕₖₗ₎*sin(θ)=n*λ.

The wide angle X-ray diffraction technique (values for the angle 2θ in the range 6° to 100°) can be used to characterize a crystalline solid defined by repetition of a unit cell or elementary lattice on a molecular scale. It follows the same physical principle as that governing the small angle X-ray diffraction technique. Thus, the wide angle XRD technique is used to analyse the materials of the invention because it is particularly suited to the structural characterization of the zeolitic nanocrystals which may be present in each of the elementary spherical particles constituting the material defined in accordance with the invention. In particular, it can be used to determine the crystallite size and the lattice parameters of these zeolitic nanocrystals. As an example, during any occlusion of ZSM-5 type (MFI) zircon nanocrystals, the associated wide angle diffractogram has peaks attributed to the space group Pnma (N° 62) of the ZSM-5 zeolite. The value of the angle obtained on the X-ray diffractogram provides access to the correlation distance d using Bragg's law: 2d₍ₕₖₗ₎*sin(θ)=n*λ.

Nitrogen volumetric analysis, corresponding to the physical adsorption of nitrogen molecules in the pores of the material via a gradual increase in the pressure at constant temperature, provides information on the textural characteristics (pore diameter, pore volume, specific surface area) particular to the material of the invention. In particular, it provides access to the specific surface area and to the mesopore distribution of the material. The term “specific surface area” means the BET specific surface area (S_{BET} in m²/g) determined by nitrogen adsorption in accordance with ASTM standard D 3663-78 derived from the BRUNAUER-EMMETT-TELLER method described in the periodical “The Journal of the American Society”, 1938, 60, 309. The pore distribution which is representative of a population of mesopores centred on a range of 2 to 50 nm (IUPAC classification) is determined from the Barrett-Joyner-Halenda model (BJH). The nitrogen adsorption-desorption isotherm in accordance with the BJH model which is obtained is described in the periodical “The Journal of the American Society”, 1951, 73, 373, written by E. P. Barrett, L. G. Joyner and P. P. Halenda. In the discussion below, the diameter φ of the mesopores of the mesostructured matrix corresponds to the maximum diameter viewed on the pore distribution obtained from the adsorption branch of the nitrogen isotherm. In addition, the shape of the nitrogen adsorption isotherm and of the hysteresis loop can provide information on the nature of the mesoporosity and on the possible presence of microporosity essentially linked to zeolitic nanocrystals when they are present in the mesostructured oxide matrix. As an example, the nitrogen adsorption isotherm relating to a mesostructured material of the invention obtained using the preparation process of the invention and constituted by elementary spherical particles comprising a mesostructured oxide matrix based on aluminium and silicon prepared using a non-ionic surfactant, namely the copolymer F127, is characterized by a class IVc adsorption isotherm (IUPAC classification) with the presence of an adsorption step for values of P/P0 (where P0 is the saturated vapour pressure at the temperature T) in the range 0.2 to 0.3 associated with the presence of pores of the order of 2 to 3 nm, as confirmed by the associated pore distribution curve.

Concerning the mesostructured matrix, the difference between the value for the pore diameter φ and the lattice parameter defined by small angle XRD as described above can be used to provide a quantity e, where e=a−φ, which is characteristic of the thickness of the amorphous walls of the mesostructured matrix included in each of the spherical particles of the material of the invention. Said lattice parameter a is linked to the correlation distance d between pores by a geometric factor which is characteristic of the geometry of the phase. As an example, in the case of a vermicular structure, e=d−φ.

Transmission electron microscopy (TEM) is also a technique which is widely used to characterize the structure of these materials. It can be used to form an image of the solid being studied, the contrasts observed being characteristics of the structural organization, the texture or the morphology of the particles observed; the maximum resolution of the technique is 1 nm. In the discussion below, the TEM photos will be produced from microtome sections of the sample in order to view a section of an elementary spherical particle of the material of the invention. As an example, the TEM images obtained for a material of the invention constituted by elementary spherical particles comprising metallic nanoparticles trapped in a mesostructured matrix based on silicon and aluminium oxide which has been prepared using a non-ionic surfactant, namely the copolymer F127, show a vermicular mesostructure within a single spherical particle (the material being defined by the dark zones) within which opaque objects might also be seen which represent the zeolitic nanocrystals trapped in the mesostructured matrix. Image analysis can also be used to provide access to the parameters d, φ and e, which are characteristic of the mesostructured matrix defined above.

The morphology and the size distribution of the elementary particles were established by analysis of the photos obtained by scanning electron microscopy (SEM).

The mesostructure of the material in accordance with the invention may be vermicular, cubic or hexagonal, depending on the nature of the surfactant selected as a template.

The metallic nanoparticles are in particular characterized by Raman spectroscopy. The Raman spectra were obtained with a dispersive type Raman spectrometer equipped with a laser with an excitation wavelength of 532 nm. The laser beam was focussed on the sample using a microscope provided with a×50 long working distance objective. The power of the laser at the sample was of the order of 1 mW. The Raman signal emitted by the sample was collected by the same objective and dispersed using a 1800 line/mm grating then collected by a CCD (Charge Coupled Device or Charge Transfer Device) detector. The spectral resolution obtained was of the order of 2 cm⁻¹. The spectral zone recorded was between 300 and 1500 cm⁻¹. The acquisition period was fixed at 120 s for each Raman spectrum recorded.

The invention will now be illustrated by means of the following examples.

### EXAMPLES

In the examples below, the aerosol technique used was that described above in the disclosure of the invention. The dispersive Raman spectrometer used was a commercial LabRAM Aramis apparatus supplied by Horiba Jobin-Yvon. The laser used had an excitation wavelength of 532 nm. The operation of this spectrograph in the execution of Examples 1-5 below was described above.

### Example 1 (Invention)

Preparation of a material comprising metallic nanoparticles based on molybdenum and cobalt containing 6% by weight of MoO₃ and 1.2% by weight of CoO with respect to the final material. The matrix is a mesostructured oxide based on aluminium and silicon with a Si/Al molar ratio=12.

An aqueous solution containing 0.29 g of MoCl₅, 0.04 g of Co(OH)₂ and 15.0 g of permutated water was prepared, with stirring, at ambient temperature.

0.69 g of aluminium trichloride was mixed with 12.1 g of permutated water and 4.40 mg of HCl. After stirring for 5 minutes at ambient temperature, 7.16 g of TEOS was added. The solution was allowed to hydrolyse for 16 h, with stirring at ambient temperature. Another solution was prepared by mixing 2.41 g of F127 (Sigma-Aldrich) into 22.4 g of permutated water, 8.20 mg of HCl and 5.29 g of ethanol.

Following hydrolysis of the solution containing the precursors of the matrix, the aquo-organic solution of F127 was added. After 5 min of homogenization, the solution containing the MoCl₅ and the Co(OH)₂ was added dropwise.

The mixture was stirred for 30 minutes then sent to the atomization chamber of the aerosol generator and the solution was sprayed in the form of fine droplets under the action of a vector gas (dry air) introduced under pressure (P=1.5 bar). The droplets were dried in accordance with the protocol described in the disclosure of the invention above: they were channelled through PVC tubes by means of an O₂/N₂ mixture. The temperature of the drying oven was fixed at 350° C. The powder recovered was then calcined under air for 5 hours at T=550° C. The solid was characterized by small angle XRD, by nitrogen volumetric analysis, by TEM, by SEM, by XRF and by Raman spectroscopy. The TEM analysis showed that the final material had an organized mesoporosity characterized by a vermicular structure. The TEM analysis could not detect the presence of any metallic nanoparticles, meaning that the dimension of said nanoparticles was below 1 nm. The nitrogen volumetric analysis produced a specific surface area of the final material of S_{BET}=160 m²/g and a mesopore diameter of 9.6 nm. The small angle XRD analysis produced a correlation peak at the angle 2θ=0.70. Bragg's law, 2d*sin(0.35)=1.5406, was used to calculate the correlation distance d between the organized mesopores of the material, i.e. d=12.6 nm. The thickness of the walls of the matrix of the mesostructured material, defined by e=d−φ, was thus e=3 nm. The Si/Al mole ratio obtained by XRF was 12. A SEM image of the spherical elementary particles obtained indicated that these particles had a dimension characterized by a diameter in the range 50 nm to 700 nm, the size distribution of these particles being centred on 300 nm. The Raman spectrum of the final material revealed the presence of polymolybdate species, interacting with the matrix, with characteristic bands for these species at 950 cm⁻¹ and 886 cm⁻¹.

### Example 2 (Invention)

Preparation of a material comprising metallic nanoparticles based on tungsten and nickel containing 5.0% by weight of WO₃ and 1.0% by weight of NiO with respect to the final material. The matrix is a mesostructured oxide based on aluminium and silicon with a Si/Al molar ratio=25.

An aqueous solution containing 0.17 g of WCl₄, 0.02 g of Ni(OH)₂ and 15.0 g of permutated water was prepared, with stirring, at ambient temperature.

0.35 g of aluminium trichloride was mixed with 12.1 g of permutated water and 4.40 mg of HCl. After stirring for 5 minutes at ambient temperature, 7.58 g of TEOS was added. The solution was allowed to hydrolyse for 16 h, with stirring at ambient temperature. Another solution was prepared by mixing 2.23 g of P123 (Sigma-Aldrich) into 22.4 g of permutated water, 8.20 mg of HCl and 5.30 g of ethanol.

Following hydrolysis of the solution containing the precursors of the matrix, the aquo-organic solution of P123 was added. After 5 min of homogenization, the solution containing the WCl₄ and the Ni(OH)₂ was added dropwise.

The mixture was stirred for 30 minutes then sent to the atomization chamber of the aerosol generator and the solution was sprayed in the form of fine droplets under the action of a vector gas (dry air) introduced under pressure (P=1.5 bar). The droplets were dried in accordance with the protocol described in the disclosure of the invention above: they were channelled through PVC tubes by means of an O₂/N₂ mixture. The temperature of the drying oven was fixed at 350° C. The powder recovered was then calcined under air for 5 hours at T=550° C. The solid was characterized by small angle XRD, by nitrogen volumetric analysis, by TEM, by SEM, by XRF and by Raman spectroscopy. The TEM analysis showed that the final material had an organized mesoporosity characterized by a vermicular structure. The TEM analysis could not detect the presence of any metallic nanoparticles, meaning that the dimension of said nanoparticles was below 1 nm. The nitrogen volumetric analysis produced a specific surface area of the final material of S_{BET}=173 m²/g and a mesopore diameter of 7.5 nm. The small angle XRD analysis produced a correlation peak at the angle 2θ=0.78. Bragg's law, 2d*sin(0.39)=1.5406, was used to calculate the correlation distance d between the organized mesopores of the material, i.e. d=11.3 nm. The thickness of the walls of the matrix of the mesostructured material, defined by e=d−φ, was thus e=3.8 nm. The Si/Al mole ratio obtained by XRF was 25. A SEM image of the spherical elementary particles obtained indicated that these particles had a dimension characterized by a diameter in the range 50 nm to 700 nm, the size distribution of these particles being centred on 300 nm. The Raman spectrum of the final material revealed the presence of polymolybdate species, interacting with the matrix, with characteristic bands for these species at 945 cm⁻¹ and 881 cm⁻¹.

### Example 3: (Invention)

Preparation of a material comprising metallic nanoparticles based on tungsten and nickel containing 9.3% by weight of WO₃ and 1.9% by weight of NiO with respect to the final material. The matrix is a mesostructured oxide based on zirconium and silicon with a Si/Zr molar ratio=10.

An aqueous solution containing 0.35 g of WCl₄, 0.04 g of Ni(OH)₂ and 15.0 g of permutated water was prepared, with stirring, at ambient temperature.

0.79 g of zirconium tetrachloride was mixed with 12.1 g of permutated water. After cooling, with stirring at ambient temperature, 7.05 g of TEOS was added. The solution was allowed to hydrolyse for 1 h, with stirring at ambient temperature. Another solution was prepared by mixing 2.41 g of F127 (Sigma-Aldrich) into 22.4 g of permutated water and 5.29 g of ethanol.

Following hydrolysis of the solution containing the precursors of the matrix, the aquo-organic solution of F127 was added. After 5 min of homogenization, the solution containing the WCl₄ and the Ni(OH)₂ was added dropwise.

The mixture was stirred for 30 minutes then sent to the atomization chamber of the aerosol generator and the solution was sprayed in the form of fine droplets under the action of a vector gas (dry air) introduced under pressure (P=1.5 bar). The droplets were dried in accordance with the protocol described in the disclosure of the invention above: they were channelled through PVC tubes by means of an O₂/N₂ mixture. The temperature of the drying oven was fixed at 350° C. The powder recovered was then calcined under air for 5 hours at T=550° C. The solid was characterized by small angle XRD, by nitrogen volumetric analysis, by TEM, by SEM, by XRF and by Raman spectroscopy. The TEM analysis showed that the final material had an organized mesoporosity characterized by a vermicular structure. The TEM analysis could not detect the presence of any metallic nanoparticles, meaning that the dimension of said nanoparticles was below 1 nm. The nitrogen volumetric analysis produced a specific surface area of the final material of S_{BET}=187 m²/g and a mesopore diameter of 8.0 nm. The small angle XRD analysis produced a correlation peak at the angle 2θ=0.60. Bragg3 s law, 2d*sin(0.30)=1.5406, was used to calculate the correlation distance d between the organized mesopores of the material, i.e. d=14.6 nm. The thickness of the walls of the matrix of the mesostructured material, defined by e=d−100 , was thus e=6.2 nm. The Si/Zr mole ratio obtained by XRF was 10. A SEM image of the spherical elementary particles obtained indicated that these particles had a dimension characterized by a diameter in the range 50 nm to 700 nm, the size distribution of these particles being centred on 300 nm. The Raman spectrum of the final material revealed the presence of polytungstate species, interacting with the matrix, with characteristic bands for these species at 942 cm⁻¹ and 879 cm⁻¹.

### Example 4 (Invention)

Preparation of a material comprising metallic nanoparticles based on molybdenum and cobalt containing 9.0% by weight of MoO₃ and 1.9% by weight of CoO with respect to the final material. The matrix is a mesostructured oxide based on aluminium and silicon with a Si/Al molar ratio=25 containing ZSM-5 type nanocrystals with a Si/Al molar ratio=50 in an amount of 5% by weight with respect to the final material.

0.14 g of aluminium tri-sec butoxide was added to a solution containing 3.50 mL of the hydroxide TPAOH, 0.01 g of sodium hydroxide, NaOH, and 4.30 mL of water. After dissolving the aluminium alkoxide, 5.90 g of tetraethylorthosilicate (TEOS) was added. The solution was stirred at ambient temperature for 5 h then autoclaved at T=95° C. for 12 h. The white solution obtained contained ZSM-5 nanocrystals with a dimension of 135 nm, measured by dynamic light scattering (DLS). This solution was centrifuged at 20000 rpm for 30 minutes. The solid was redispersed in water then centrifuged again at 20000 rpm for 30 minutes. This washing was carried out twice. The nanocrystals formed a gel which was oven dried overnight at 60° C.

An aqueous solution containing 0.43 g of MoCl₅, 0.06 g of Co(OH)₂ and 15.0 g of permutated water was prepared, with stirring, at ambient temperature.

0.34 g of aluminium trichloride was mixed with 12.1 g of permutated water and 4.40 mg of HCl. After stirring for 5 min at ambient temperature, 7.38 g of TEOS was added. The solution was allowed to hydrolyse for 16 h, with stirring at ambient temperature. Another solution was prepared by mixing 2.42 g of F127 (Sigma-Aldrich) into 22.5 g of permutated water, 8.20 mg of HCl and 5.31 g of ethanol in which 0.143 g of ZSM-5 zeolite nanocrystals had been redispersed.

Following hydrolysis of the solution containing the precursors of the matrix, the aquo-organic solution of F127, containing the ZSM-5 zeolite nanocrystals, was added. After stirring for 5 min at ambient temperature, the solution containing the MoCl₅ and the Co(OH)₂ was added dropwise.

The mixture was stirred for 30 minutes then sent to the atomization chamber of the aerosol generator and the solution was sprayed in the form of fine droplets under the action of a vector gas (dry air) introduced under pressure (P=1.5 bar). The droplets were dried in accordance with the protocol described in the disclosure of the invention above: they were channelled through PVC tubes by means of an O₂/N₂ mixture. The temperature of the drying oven was fixed at 350° C. The powder recovered was then calcined under air for 5 hours at T=550° C. The solid was characterized by small angle and wide angle XRD, by nitrogen volumetric analysis, by TEM, by SEM, by XRF and by Raman spectroscopy. The TEM analysis showed that the final material had an organized mesoporosity characterized by a vermicular structure in which zeolite nanocrystals with a dimension of 135 nm were trapped. The TEM analysis could not detect the presence of any metallic nanoparticles, indicating that said nanoparticles had a dimension of less than 1 nm. The nitrogen volumetric analysis produced a specific surface area of the final material of S_{BET}=260 m²/g and a mesopore diameter of 9.0 nm. The small angle XRD analysis produced a correlation peak at the angle 2θ=0.67. Bragg's law, 2d*sin(0.33) =1.5406, was used to calculate the correlation distance d between the organized mesopores of the material, i.e. d=13.1 nm. The thickness of the walls of the mesostructured material, defined by e=d−φ, was thus e=4.1 nm. The wide angle XRD analysis produced a diffractogram which was characteristic of ZSM-5 zeolite. The Si/Al mole ratio of the matrix was 25 and that of the ZSM-5 nanocrystals was 50. These two Si/Al ratios were determined by TEM analysis coupled with EDX. A SEM image of the spherical elementary particles obtained indicated that these particles had a dimension characterized by a diameter in the range 50 nm to 700 nm, the size distribution of these particles being centred on 300 nm. The Raman spectrum of the final material revealed the presence of polymolybdate species, interacting with the matrix, with characteristic bands for these species at 953 cm⁻¹ and 890 cm⁻¹.

### Example 5 (Invention)

Preparation of a material comprising metallic nanoparticles based on tungsten and nickel containing 6% by weight of WO₃ and 1.25% by weight of NiO with respect to the final material. The matrix is a mesostructured oxide based on aluminium and silicon with a Si/Al molar ratio=12 containing ZSM-5 type zeolite nanocrystals with a Si/Al molar ratio=50 in an amount of 5% by weight with respect to the final material.

0.14 g of aluminium tri-sec butoxide was added to a solution containing 3.50 mL of the hydroxide TPAOH, 0.01 g of sodium hydroxide, NaOH, and 4.30 mL of water. After dissolving the aluminium alkoxide, 5.90 g of tetraethylorthosilicate (TEOS) was added. The solution was stirred at ambient temperature for 5 h then autoclaved at T=95° C. for 12 h. The white solution obtained contained nanocrystals of ZSM-5 with a dimension, measured by DLS, equal to 135 nm. This solution was centrifuged at 20000 rpm for 30 minutes. The solid was redispersed in water then centrifuged again at 20000 rpm for 30 minutes. This washing was carried out twice. The nanocrystals formed a gel which was oven dried overnight at 60° C.

An aqueous solution containing 0.21 g of WCl₄, 0.02 g of Ni(OH)₂ and 15.0 g of permutated water was prepared, with stirring, at ambient temperature.

0.70 g of aluminium trichloride was mixed with 12.0 g of permutated water and 4.40 mg of HCl. After stirring for 5 min at ambient temperature, 7.22 g of TEOS was added. The solution was allowed to hydrolyse for 16 h, with stirring at ambient temperature. Another solution was prepared by mixing 2.41 g of F127 (Sigma-Aldrich) into 22.3 g of permutated water, 8.20 mg of HCl and 5.28 g of ethanol in which 0.139 g of ZSM-5 zeolite nanocrystals had been redispersed.

Following hydrolysis of the solution containing the precursors of the matrix, the aquo-organic solution of F127 containing the ZSM-5 nanocrystals was added. After stirring for 5 min at ambient temperature, the solution containing the WCl₄ and the Ni(OH)₂ was added dropwise.

The mixture was stirred for 30 minutes then sent to the atomization chamber of the aerosol generator and the solution was sprayed in the form of fine droplets under the action of a vector gas (dry air) introduced under pressure (P=1.5 bar). The droplets were dried in accordance with the protocol described in the disclosure of the invention above: they were channelled through PVC tubes by means of an O₂/N₂ mixture. The temperature of the drying oven was fixed at 350° C. The powder recovered was then calcined under air for 5 hours at T=550° C. The solid was characterized by small angle and wide angle XRD, by nitrogen volumetric analysis, by TEM, by SEM, by XRF and by Raman spectroscopy. The TEM analysis showed that the final material had an organized mesoporosity characterized by a vermicular structure in which zeolite nanocrystals with a dimension of 135 nm were trapped. The TEM analysis could not detect the presence of any metallic nanoparticles, indicating that said nanoparticles had a dimension of less than 1 nm. The nitrogen volumetric analysis produced a specific surface area of the final material of S_{BET}=277 m²/g and a mesopore diameter of 9.2 nm. The small angle XRD analysis produced a correlation peak at the angle 2θ=0.64. Bragg's law, 2d*sin(0.32) =1.5406, was used to calculate the correlation distance d between the organized mesopores of the material, i.e. d=13.6 nm. The thickness of the walls of the matrix of the mesostructured material, defined by e=d−φ, was thus e=4.4 nm. The wide angle XRD analysis produced a diffractogram which was characteristic of ZSM-5 zeolite. The Si/Al mole ratio of the matrix was 12 and that of the ZSM-5 nanocrystals was 50. These two Si/Al ratios were determined by TEM analysis coupled with EDX. A SEM image of the spherical elementary particles obtained indicated that these particles had a dimension characterized by a diameter in the range 50 nm to 700 nm, the size distribution of these particles being centred on 300 nm. The Raman spectrum of the final material revealed the presence of polytungstate species, interacting with the matrix, with characteristic bands for these species at 944 cm⁻¹ and 883 cm⁻¹.

1. An inorganic material constituted by at least two elementary spherical particles, each of said spherical particles comprising metallic nanoparticles having at least one band with a wave number in the range 750 to 1050 cm⁻¹ in Raman spectroscopy and containing at least one or more metals selected from vanadium, niobium, tantalum, molybdenum and tungsten, said metallic nanoparticles being present within a mesostructured matrix based on an oxide of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, said matrix having pores with a diameter in the range 1.5 to 50 nm and having amorphous walls with a thickness in the range 1 to 30 nm, said elementary spherical particles having a maximum diameter of 200 microns and said metallic nanoparticles having a maximum dimension strictly less than 1 nm.

2. A material according to claim 1, in which said mesostructured matrix is constituted by aluminium oxide, silicon oxide, a mixture of silicon oxide and aluminium oxide or a mixture of silicon oxide and zirconium oxide.

3. A material according to claim 1, in which said matrix has pores with a diameter in the range 4 to 20 nm.

4. A material according to claim 1, in which said matrix has amorphous walls with a thickness in the range 1 to 10 nm.

5. A material according to claim 1, in which said metallic nanoparticles contain molybdenum and/or tungsten.

6. A material according to claim 1, in which said metallic nanoparticles have at least one band with a wave number in the range 750 to 950 cm⁻¹ or in the range 950 to 1050 cm⁻¹ in Raman spectroscopy.

7. A material according to claim 1, in which each of the spherical particles comprises zeolitic nanocrystals representing 0.1% to 30% by weight of said material.

8. A material according to claim 7, in which said zeolitic nanocrystals comprise at least one zeolite selected from zeolites with structure type MFI, BEA, FAU and LTA.

9. A material according to claim 1, in which each of the spherical particles comprises one or more additional element(s) selected from organic agents, metals from group VIII of the periodic classification of the elements and doping species belonging to the list of doping elements constituted by phosphorus, fluorine, silicon and boron and their mixtures.

10. A material according to claim 9, in which said metal from group VIII as the additional element is selected from cobalt, nickel and a mixture of these two metals.

11. A material according to claim 1, having a specific surface area in the range 50 to 1100 m²/g.

12. A process for preparing an inorganic material according to claim 1, comprising at least the following steps in succession:
a) mixing in solution:
at least one surfactant;
at least one precursor of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements;
at least one first metallic precursor containing at least one or more metals selected from vanadium, niobium, tantalum, molybdenum and tungsten present in metallic nanoparticles having at least one band with a wave number in the range 750 to 1050 cm⁻¹ in Raman spectroscopy;
optionally, at least one colloidal solution in which zeolite crystals with a maximum nanometric dimension equal to 300 nm are dispersed;
b) aerosol atomisation of said solution obtained in step a) in order to result in the formation of spherical liquid droplets; c) drying said droplets; d) eliminating at least said surfactant.

13. A preparation process according to claim 12, in which at least said first metallic precursor based on a metal selected from vanadium, niobium, tantalum, molybdenum and tungsten, and at least one second monometallic precursor based on a metal from group VIII are dissolved prior to carrying out said step a), said solution then being introduced into the mixture in accordance with said step a).

14. A process for the transformation of a hydrocarbon feed, comprising 1) bringing a mesostructured inorganic material according to claim 1 into contact with a feed comprising at least one sulphur-containing compound, then 2) bringing said material obtained from said step 1) into contact with said hydrocarbon feed.

15. A transformation process according to claim 14, in which said feed comprises molecules containing heteroelements selected from nitrogen, oxygen and/or sulphur.
